(19) United States
(12) Patent Application Publication
(10) Pub. No.: US 2007/0028890 A1
(43) Pub. Date: Feb. 8, 2007

(54) Turbocharged internal combustion engine and method of operating same

(76) Inventors: Cory A. Brown, Pekin, IL (US); Roger L. Urven JR., Colona, IL (US); Anthony C. Rodman, Chillicothe, IL (US)

Correspondence Address: CATERPILLAR c/o LIELL & MCNEIL ATTORNEYS PC, P.O. BOX 2417, 511 SOUTH MADISON STREET, BLOOMINGTON, IN, 47402-2417, US

(21) Appl. No.: 11/199,415

(22) Filed: Aug. 8, 2005

(51) Int. Cl. F02D 41/40

(52) U.S. Cl. 123/299; 123/305

(57) ABSTRACT

The present disclosure provides a turbocharged internal combustion engine and a method of operating the same. The method includes operating the engine in a first mode wherein fuel in injected prior to autoignition conditions in at least one cylinder of the engine. The method further includes selectively operating the engine in a second operating mode that includes fuel injection after autoignition conditions, where a value indicative of turbocharger boost pressure meets a predetermined criterion, such as boost pressure being too low. The internal combustion engine of the present disclosure includes an article have a computer readable medium with a control algorithm recorded thereon. The control algorithm includes first means for operating the engine in a homogeneous charge mode, and second means for selectively operating the engine in a mixed homogeneous charge and conventional mode, where a value indicative of a turbocharger boost pressure meets a predetermined criterion.

### STATEMENT OF GOVERNMENT INTEREST

The United States Government has certain rights in the present patent application, and any patent that may issue thereon, under DOE Contract No. FC05-97OR22605.

### TECHNICAL FIELD

The present disclosure relates generally to turbocharged internal combustion engines and operating methods therefor. More particularly, the present disclosure relates to a method of operating such an engine in a different mode if a value indicative of a turbocharger boost pressure meets a predetermined criterion.

### BACKGROUND

The sophistication of internal combustion engines and engine operating schemes continues to increase, and innovations in design and operation are revealed almost daily. One driving force behind many of the design changes in recent years have been increasingly stringent emissions requirements. One general approach to improving emissions quality relates to treatment of combustion products downstream from the engine. In other words, exhaust gases produced by the engine are treated via a variety of chemical and/or physical processes in an attempt to remove or reduce undesired constituents. Other engine developers have focused more on the combustion process itself. Manipulation of fuel injection quantity, frequency, timing and even the type of spray pattern has been shown to have various effects on engine emissions. Of particular interest to engineers are the increasingly stringent government requirements relating to emission limits on various nitrogen-oxygen compounds, known collectively as “NOx”.

It has been discovered that premixing of air and fuel prior to ignition in an internal combustion engine cylinder can have help reduce NOx levels in the engine exhaust. One approach in particular is known in the art as “homogeneous charge” ignition. In compression ignition engines, this approach is widely referred to as “HCCI”. In a homogeneous charge mode, fuel may be injected into a compression ignition engine cylinder prior to the point during an engine cycle at which cylinder conditions will trigger autoignition. This differs from a more traditional approach, wherein fuel is primarily injected during an engine cycle near top dead center or otherwise at a point at which autoignition can occur. In other words, rather than fuel more or less continuously combusting as it leaves the fuel injector tip, in HCCI mode the fuel may be injected in advance of autoignition conditions, such that the fuel and air have relatively more time to mix as the piston travels upward in the cylinder.

Homogeneous charge operation tends to be relatively sensitive to various operating conditions external to and internal of the engine. Ambient temperature and pressure, as well as the timing of autoignition conditions in the engine cycle, for example, can affect the ability of an engine to successfully operate in a homogeneous charge mode. Such engines are commonly coupled with a turbocharger, introducing various additional challenges to successful and predictable operation.

In particular, because HCCI operation transforms combustion energy to mechanical energy relatively efficiently, turbocharger boost pressures during HCCI operation may be relatively lower for a given combusted fuel quantity. Relatively more energy of combustion in a given cylinder is transformed into the mechanical energy of piston motion than during conventional operation. Less energy is thus transferred in the form of heat and gas pressure to the exhaust system, resulting in a relatively lower turbocharger speed than might be expected from conventional operation. This phenomenon is particularly evident where an engine is operating in HCCI mode toward a lower portion of its available power range, for instance at low load or idle.

While the enhanced efficiency of HCCI operation offers various advantages, injected fuel in an HCCI mode tends to ignite more uniformly, in many cases generating relatively greater peak cylinder pressures and cylinder pressure spikes than conventional ignition of a similar fuel quantity. As power demands and thus injected fuel quantity are increased, the engine may reach a point at which HCCI-derived physical stresses on the engine risk damage to the engine hardware.

Control over the cylinder pressure rise rate and peak cylinder pressures has heretofore typically been accomplished by operating at a high air-to-fuel ratio, or by adding a diluent such as exhaust gas to the combustion mixture. These approaches, however, have in many instances been shown to be ineffective at managing cylinder pressures resulting from HCCI operation.

U.S. Pat. No. 6,561,157 to zur Loye et al. describes one type of turbocharged internal combustion engine having multiple operating modes. While the zur Loye system appears capable of switching modes to meet various engine operating demands and conditions, it utilizes a dual-fuel system, requiring relatively complex hardware and electronic controls.

The present disclosure is directed to one or more of the problems or shortcomings set forth above.

### SUMMARY OF THE INVENTION

In one aspect, the present disclosure provides a method of operating an internal combustion engine that includes at least one cylinder having a fuel injector disposed at least partially therein. The method includes the steps of, operating the engine in a first mode that includes injecting a fuel charge into the at least one cylinder prior to a time at which autoignition conditions have arisen in a given engine cycle, and determining a value indicative of a boost pressure of a turbocharger coupled with the engine. The method further includes the step of, selectively operating the engine in a second mode that includes injecting a fuel charge into the at least one cylinder after a time at which autoignition conditions have arisen in at least one subsequent engine cycle, if the determined value meets a predetermined criterion.

In another aspect, the present disclosure provides an internal combustion engine, including an engine housing having at least one cylinder. A fuel injector is disposed at least partially within the at least one cylinder. The internal combustion engine further includes a turbocharger, and means for determining a value indicative of a boost pressure of the turbocharger. An electronic controller is further provided and is coupled with the turbocharger and with the means for determining. The electronic controller includes a computer readable medium with a control algorithm recorded thereon. The control algorithm includes means for operating the engine in a first mode that includes injecting fuel into the at least one cylinder prior to a time at which autoignition conditions have arisen in the at least one cylinder. The control algorithm further includes means for selectively operating the engine in a second mode that includes injecting fuel into the at least one cylinder after a time at which autoignition conditions have arisen in the at least one cylinder, if the determined value meets a predetermined criterion.

In still another aspect, the present disclosure provides an article that includes a computer readable medium having a control algorithm recorded thereon. The control algorithm includes means for determining a value indicative of a boost pressure of a turbocharger in an internal combustion engine having at least one cylinder with a fuel injector disposed at least partially therein. The control algorithm further includes first means for operating the engine in a homogenous charge mode where the determined value is above a predetermined threshold and a second means for selectively operating the engine in a mixed homogenous charge and conventional mode where the predetermined value is below the predetermined threshold.

### BRIEF DESCRIPTION OF THE DRAWINGS

FIG. 1 is a diagrammatic side view of an internal combustion engine according to the present disclosure;

FIG. 2 is a partially sectioned side view of a portion of the internal combustion engine of FIG. 1;

FIG. 3 is a flowchart illustrating a control process according to the present disclosure; and

FIG. 4 is a flowchart illustrating another control process according to the present disclosure.

### DETAILED DESCRIPTION

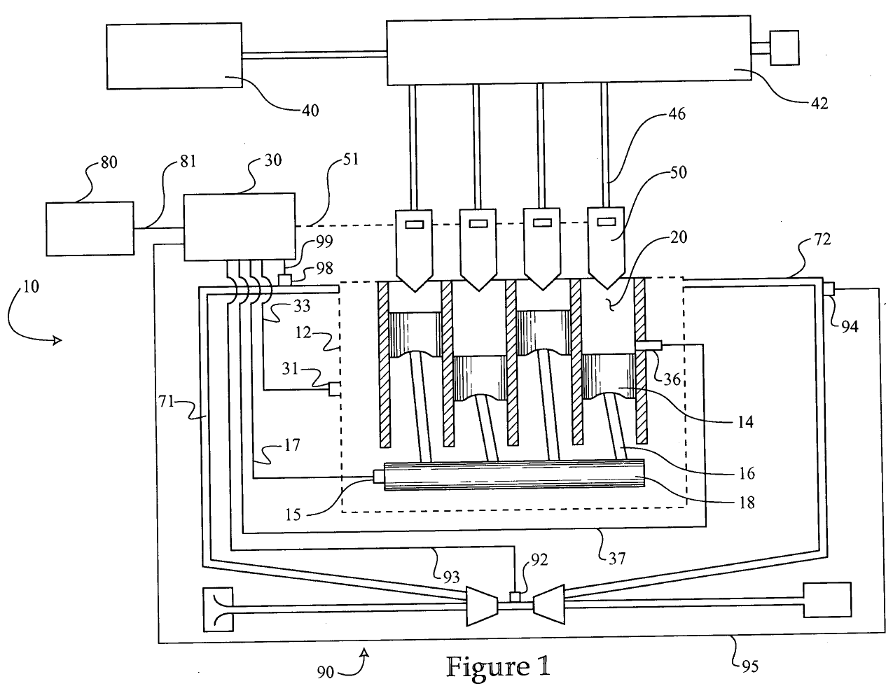

Referring to FIG. 1, there is shown an engine 10 according to the present disclosure. Engine 10 includes an engine housing 12 having at least one cylinder 20, for example, a plurality of cylinders disposed therein. Engine 10 may further include a piston 14 positioned at least partially within cylinder 20 and reciprocable therein in a conventional manner. A piston rod 16 connects piston 14 with a crankshaft 18 in a conventional manner. A source of pressurized fuel, such as distillate diesel fuel, or a pump 40 may be provided and fluidly connected to a plurality of fuel injectors 50 via a common rail 42 and supply passages 46. Engine 10 will typically include plural cylinders, each with a corresponding fuel injector, however, for clarity the present description refers primarily to cylinder 20 and fuel injector 50 in the singular. While it is contemplated that in one embodiment, engine 10 will be a common rail diesel engine, alternative embodiments are contemplated, for example an engine having one or more unit pumps coupled with the respective fuel injectors, or an engine using another fuel type such as a gaseous hydrocarbon fuel. Engine housing 12 may further be coupled with an intake manifold 71, an exhaust manifold 72, and a turbocharger 90.

Engine 10 may further include an electronic controller 30 operable to control and/or monitor certain aspects of operation of engine 10. In the embodiment shown in FIG. 1, electronic controller 30 is in communication with a set of operator controls 80 via a communication line 81. Electronic controller 30 may also be in communication with a pressure sensor 36 exposed to a fluid pressure of cylinder 20. For example, pressure sensor 36 may be disposed at least partially within cylinder 20 and coupled with electronic controller 30 via a communication line 37. Embodiments are contemplated wherein only one cylinder includes a pressure sensor associated therewith, as well as embodiments where more than one or all of the engine cylinders are coupled with a pressure sensor. Pressure sensor 36 may be any of a variety of pressure sensors known in the art, for example, a piezo-resistive sensor having a diaphragm that is deflected by fluid pressure from cylinder 20.

Engine 10 may further include a temperature sensor 94 disposed at least partially within exhaust manifold 72, or elsewhere in the exhaust system, and in communication with electronic controller 30 via a communication line 95. A turbocharger shaft speed sensor 92 may be coupled with turbocharger 90 and in communication with electronic controller 30 via another communication line 93. An intake manifold pressure sensor 98 may also be provided and exposed to a fluid pressure of intake manifold 71, and in communication with electronic controller 30 via yet another communication line 99. Engine 10 may further include a crank angle sensor 15 coupled with electronic controller 30 via a communication line 17. Further still, engine 10 may include a speed and/or load sensor 31 coupled with electronic controller 30 via yet another communication line 33.

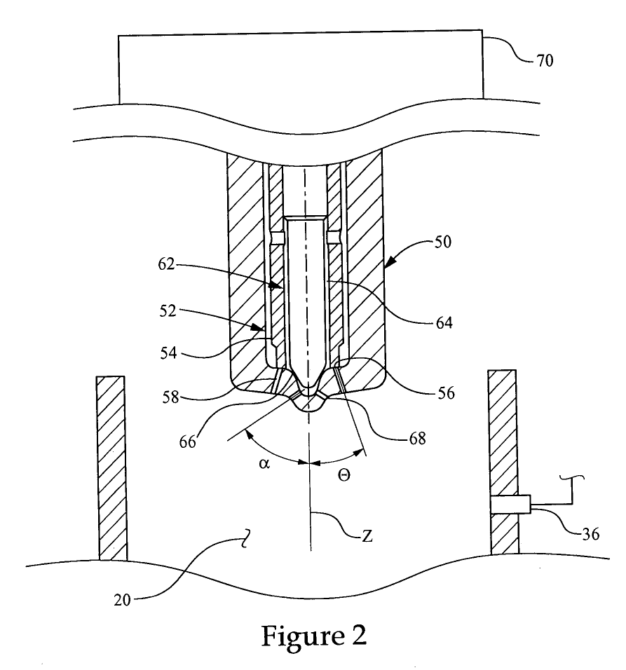

Referring also to FIG. 2, electronic controller 30 may also be in control communication with each fuel injector 50 via another communication line 51. Each fuel injector 50 may be a conventional fuel injector or a mixed mode fuel injector disposed at least partially within cylinder 20. A variety of suitable mixed mode fuel injectors are known in the art. One exemplary mixed mode fuel injector is known from U.S. Pat. No. 6,725,838 to Shafer et al. Another suitable mixed mode fuel injector is injector 50, a portion of which is shown in FIG. 2.

Injector 50 may be a dual concentric check fuel injector, including a first or outer check 52 and a second or inner check 62. Outer check 52 may include a first valve member 54 operable to open or close a first set of injection orifices 58 by moving away from or against a first seat 56, respectively. Inner check 62 in turn may include a second valve member 64 operable to open or close a second set of injection orifices 68 different from first set 58 by moving away from or against a second seat 66, respectively. A control valve assembly 70 may be coupled with fuel injector 50 and with electronic controller 30 to control the opening and closing of outer check 52 and inner check 62. In one contemplated embodiment, electronic controller 30 will be operable to selectively open one or both of first check 52 and second check 62 to inject fuel through the desired corresponding set(s) of injection orifices. Electronic controller 30 may further be operable to command the respective injection(s) at a selected time during a given engine cycle, as described herein.

First set of injection orifices 58 may include a plurality of injection orifices disposed at a first average spray angle α relative to an axis Z of cylinder 20. Second set of injection orifices 68 may include a plurality of injection orifices different from first set 58 that are disposed at a second average spray angle θ relative to axis Z that is larger than first average spray angle α. Injection orifices 58 define a first spray pattern of fuel injector 50, whereas injection orifices 68 define a second, different spray pattern of fuel injector 50. It is contemplated that fuel injection via first set of injection orifices 58 may be primarily for homogeneous charge mode or HCCI operation, whereas fuel injection via second set 68 may be primarily for conventional difusion burn operation. Simultaneous injection via both first set 58 and second set 68 may take place, for example where a relatively large fuel injection volume is desired per each injection. Mixed or sequential homogeneous charge and conventional mode operation may be selectively employed during the same engine cycle, as described herein. Those skilled in the art will appreciate that alternative means for providing different spray patterns might be employed without departing from the scope of the present disclosure. For instance, rather than separate sets of injection orifices having different average spray angles, sets of orifices having different sizes or different numbers might be utilized to provide more than one available spray pattern of fuel injector 50. Further still, a conventional fuel injector having only one spray pattern may also be employed.

The present disclosure further provides a method of operating an internal combustion engine 10 that includes at least one cylinder 20 with a fuel injector disposed at least partially therein, for example, mixed mode injector 50. The method is primarily directed toward increasing the turbocharger boost pressure to manage cylinder pressures and pressure spikes from HCCI combustion events. Pressurized air supplied by turbocharger 90 to cylinder 20 may have the effect of limiting cylinder pressure spikes and peak cylinder pressures in some instances. This is believed to be due at least in part to constituents of the air acting essentially as an inert heat sink during combustion, giving the pressurized cylinder charge air a relatively higher heat capacity than un-pressurized ambient air. The HCCI combustion rise rate and peak cylinder pressures may thus be maintained at acceptable levels. The remaining, uncombusted oxygen in the charge air may be used in a subsequent, conventional combustion event, as described herein.

The method may include the step of, operating engine 10 in a first mode that includes injecting a fuel charge into the at least one cylinder 20, prior to a time at which autoignition conditions have arisen in a given engine cycle. Injection of the fuel charge in the first operating mode may include the step of injecting the fuel charge into cylinder 20 via the first spray pattern of fuel injector 50, for instance, the HCCI spray pattern defined by first set of injection orifices 58. The step of injecting the fuel charge may further include injecting the fuel charge during a given engine cycle prior to a point at which the corresponding piston 14 is at a top dead center position. The first operating mode may be a pure HCCI mode.

The method may further include the step of determining a value indicative of a boost pressure of turbocharger 90. As used herein, the phrase “value indicative of” should be understood to refer to both direct measurements of the parameter or characteristic of interest, as well as estimations and/or inferences thereof, and indirect measurements of another parameter or characteristic having a known relationship to the parameter or characteristic of interest. One means for determining the value indicative of boost pressure will be via intake manifold pressure sensor 98, operable to determine the gas pressure in intake manifold 71. Another means for determining the value indicative of boost pressure is temperature sensor 94. Exhaust temperature is an example of a value allowing an indirect determination/estimation of the characteristic of interest, as turbocharger speed, and thus boost pressure will typically be related to the temperature of the engine exhaust. Yet another means for determining the value indicative of boost pressure is via speed sensor 92. Turbocharger shaft speed is known to relate to boost pressure and, thus a value indicative of boost pressure may be determined by measuring turbocharger shaft speed.

The method may further include the step of selectively operating engine 10 in a second mode that includes injecting a fuel charge into cylinder 20 after a time at which autoignition conditions have arisen in at least one subsequent engine cycle, if the determined value indicative of boost pressure meets a predetermined criterion. For instance, operation in the second mode may take place where the determined value is below a predetermined threshold, i.e. boost pressure is too low. Operation in the second mode may also include injection of another fuel charge during the at least one subsequent engine cycle, prior to a time at which autoignition conditions have arisen. In other words, the second operating mode may include a mixed mode, with both HCCI and conventional injections in the same engine cycle. When operating in a mixed mode version of the second mode, it is contemplated that injection of the first and second fuel charges will typically take place during the same engine cycle, however, conventional injection and HCCI injection might take place in successive or alternating engine cycles to increase the speed of turbocharger 90, and thus increase the boost pressure thereof, as described herein.

Thus, operation in a mixed mode embodiment of the second mode may include a first injection and a second injection, before and after autoignition conditions, respectively, in one or more subsequent engine cycles. Injection of a first fuel charge may be an HCCI injection via the first spray pattern of injector 50, whereas injection of a second fuel charge may be a conventional-type injection, via the second spray pattern of injector 50. It is further contemplated that injection of the second fuel charge may take place at or after piston 14 has reached a top dead center position during a given engine cycle. In other words, injection of the second fuel charge may take place subsequent to the point at which autoignition conditions have initially developed in cylinder 20.

As with any combustion event in an internal combustion engine, a portion of the combustion energy from combusting the second, conventional fuel charge will not be transformed into mechanical energy in cylinder 20. Some of the energy remaining after combustion within cylinder 20, in the form of pressure and temperature of combustion products and maybe even uncombusted gases exiting cylinder 20 may be converted into mechanical energy in turbocharger 90 in a conventional manner. In general terms, a relatively longer delay following the initial development of autoignition conditions in cylinder 20 will allow a relatively larger proportion of the available combustion energy to be transferred to turbocharger 90.

Thus, the timing of injection of the second fuel charge may depend at least in part on what relative proportion of the available combustion energy it is desired to send to turbocharger 90. Where it is desirable to relatively rapidly increase turbocharger speed, and consequently boost pressure, injection of the second fuel charge may take place at a point in time relatively later in a given engine cycle. The delay between development of antoignition conditions and the timing of injection of the second fuel charge may be adjusted to vary the relative proportion of combustion energy that is transformed into mechanical energy in cylinder 20, versus the combustion energy transformed into mechanical energy in turbocharger 90. Where it is desirable to increase turbocharger speed relatively more gradually, the second injection may take place relatively earlier in the engine cycle, for example, just before or substantially simultaneous with the development of autoignition conditions, as is common in conventional compression ignition operation.

Those skilled in the art will appreciate that the relative timing of the conventional injection in the second operating mode may impact the emissions quality of engine 10. For instance, injecting fuel relatively later in a given engine cycle, while typically yielding relatively more exhaust energy that may be harnessed by turbocharger 90 than an earlier, conventional injection, may increase the proportion of various undesirable emissions from engine 10.

The quantity of fuel injected in the second fuel charge may likewise be varied depending on the amount of combustion energy it is desired to utilize at turbocharger 90. This predetermined quantity of fuel may be selected based at least in part on the determined value indicative of boost pressure. For example, where boost pressure is relatively low, it may be desirable to inject a relatively larger quantity of fuel in the at least one subsequent engine cycle per each second fuel charge. Where boost pressure is relatively high, yet still meeting the predetermined criterion, e.g. below the predetermined threshold, it may be desirable to inject a relatively smaller quantity of fuel per each second fuel charge.

It is well known in the art that conventional engine operation will typically yield relatively poorer emissions quality than HCCI, at least with respect to certain emissions. Thus, the desirability of relatively larger fuel injection quantities in the second injection may depend on the desired or permitted emissions profile for engine 10. Similarly, as also discussed herein, the relative timing of the second injection may impact the emissions profile, and designers/operators may balance various factors in arriving at a particular operating strategy.

It is further contemplated that selective operation in the second mode according to the present disclosure will primarily be used where engine 10 is in a lower portion of a power output range. Where engine 10 is operating at relatively high speeds or loads, for example, turbocharger 90 will typically be providing sufficient boost pressure such that operation in a pure HCCI mode will be practicable.

Electronic controller 30 may include a computer readable medium such as RAM, ROM or some other medium, having a control algorithm recorded thereon. The control algorithm may include means for operating engine 10 in the first mode, for example including injecting a fuel into cylinder 20 via the first spray pattern of mixed mode fuel injector 50 prior to a time at which autoignition conditions have arisen in cylinder 20, for HCCI operation. The control algorithm may further include means for selectively operating engine 10 in the second mode, for example including injecting a fuel into cylinder 20 via the second spray pattern of mixed mode fuel injector 50 after a time at which autoignition conditions have arisen in cylinder 20, if the determined value indicative of boost pressure meets the predetermined criterion, as described herein.

In one contemplated embodiment, the control algorithm may also include means for determining the value indicative of the boost pressure of turbocharger 90. The control algorithm of such an embodiment may further include first means for operating engine 10 in a conventional mode, and second means for operating engine 10 in a mixed homogeneous charge and conventional mode, where the determined value meets the predetermined criterion.

The control algorithm may further include means for determining a value indicative of a crank angle of engine 10, during a particular engine cycle. The means for selectively operating engine 10 in the second mode may include means for injecting the first, or HCCI, fuel charge at a time during the at least one subsequent engine cycle prior to a predetermined crank angle range, for example, corresponding to a time prior to autoignition conditions. The means for selectively operating engine 10 in the second mode may further include means for injecting the second, or conventional, fuel charge at a time during the at least one subsequent engine cycle that is later than the predetermined crank angle range, for example, corresponding to a time after autoignition conditions have arisen.

The control algorithm may be an open loop control algorithm, including at least one map. A determined boost pressure may itself serve as the trigger for beginning operation in the second mode. Other variables relating to boost pressure may also trigger operation in the second mode. For instance, where turbocharger shaft speed is below a particular threshold, or within a predetermined range, supplemental, conventional injections via the second operating mode may be desirable and engine operation may be transitioned from the first operating mode to the second operating mode. Similarly, where the power output of engine 10 is below a certain threshold, operation in the second mode may be desirable. Exhaust temperature or power demands might also serve as indicators that greater boost pressure will be required. Any of injection pressure, duration or timing of the second, conventional injection may be specifically mapped to a particular boost pressure, exhaust temperature, etc. Such maps may be developed based on laboratory test machines, computer modeling, etc. The at least one map may comprise a look-up table, neural network or the like.

The control algorithm may also be a closed loop control algorithm, for example, including a feedback term corresponding to a cylinder pressure and/or rate of change in cylinder pressure of cylinder 20. In such an embodiment, electronic controller 30 may monitor cylinder pressure and/or rate of change therein. Where cylinder pressure reaches a predetermined threshold and/or predetermined maximum desirable rate of rise per a given engine cycle, electronic controller 30 may selectively initiate operation in the second mode and command conventional fuel injection in the at least one subsequent engine cycle to elevate the boost pressure. Electronic controller 30 may continuously monitor the cylinder pressure characteristics, such that the conventional injection per each engine cycle may be continued so long as necessary to return cylinder pressures to acceptable levels, or maintain cylinder pressures within an acceptable range.

### INDUSTRIAL APPLICABILITY

It is contemplated that the method of the present disclosure will be applicable where engine 10 is in a lower portion of an available power output range. When operating in a pure HCCI mode (the first mode) at lower power levels, the boost pressure from turbocharger 90 may not be sufficient to allow operation without the risk of compromising engine hardware by excessive cylinder pressures and cylinder pressure spikes. As described herein, pure HCCI operation tends to result in relatively less available exhaust energy for powering turbocharger 90, as the injected fuel tends to undergo relatively cooler combustion as well as igniting relatively more rapidly and burning more completely, converting a relatively greater proportion of combustion energy to mechanical energy of piston 14 than with conventional injections. Accordingly, the second operating mode, for example using both an HCCI injection and a conventional injection per each engine cycle may be utilized to provide additional exhaust energy to “spin up” turbocharger 90 until it is providing the desired boost pressure. Conventional injections may be used in concert with HCCI injections during a given engine cycle, however, conventional operation alone might be used until turbocharger 90 is providing the requisite boost pressure, as described herein. The same cylinder might alternate between pure HCCI mode and a conventional mode in successive engine cycles to increase boost pressure as per this disclosure. The present method may be applicable where engine 10 is operating continuously in a lower portion of its available power output range as well as where the power output of engine 10 is being increased across a lower load range.

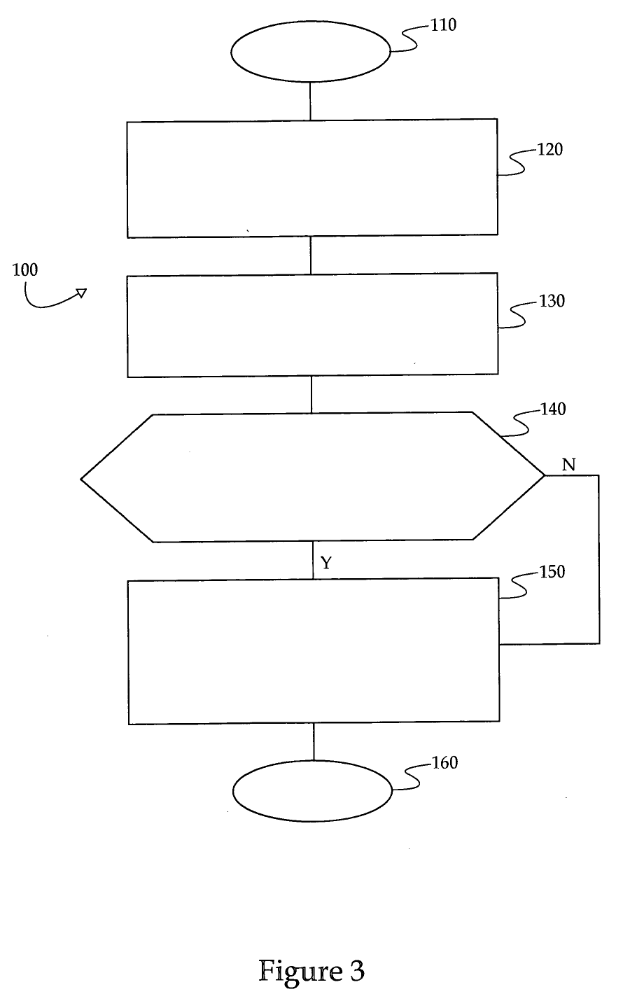

Turning to FIG. 3, there is shown an exemplary control process according to the present disclosure shown in the context of a flowchart 100. The process begins at a START, Box 110. From Box 110, the process may proceed to Box 120, wherein engine 10 is operated in its first mode, for example via injection of a fuel charge via the first spray pattern of mixed mode injector 50 in a given engine cycle. It will be recalled that injection via the first spray pattern may be via first set of injection orifices 66 such that fuel is directed relatively deeply into cylinder 20 rather than toward the walls thereof. As described, each injection in the first mode may be an HCCI injection effected prior to a point in time at which autoignition conditions have arisen in cylinder 20, e.g. prior to the point at which piston 14 reaches a top dead center position.

From Box 120 the process may proceed to Box 130 wherein the described value indicative of boost pressure may be determined. As described, any of a number of parameters may be measured, estimated or inferred to determine the subject value. Electronic controller 30 may, for instance, determine the intake manifold air pressure via sensor 98. From Box 130 the process may proceed to Box 140 wherein electronic controller 30 may determine whether the value is below a predetermined threshold. The predetermined threshold may represent a boost pressure that is adequate to ensure that cylinder pressures and cylinder pressure spikes remain within limits that may be accommodated by engine 10. Where the threshold in not reached, the second mode will be employed and conventional injections will be used to spin-up turbocharger 90, either in conjunction with HCCI injections or alone.

Where boost pressure is not below the predetermined threshold, electronic controller 30 may determine that supplemental conventional fuel injections are not necessary and the process may proceed to Box 160, a FINISH. Where the process proceeds from Box 140 directly to Box 160, the control logic for switching between modes may be disabled, as engine 10 may be determined to be operating in a power output range, or above a predetermined power output threshold where sufficient boost pressure is provided without the need to resort to conventional injections. Disabling of the control logic for switching modes might also be mapped directly to power output. Where engine 10 returns to a lower portion of its available power output range, however, or where the boost pressure returns to below the predetermined threshold, the control logic may be reactivated such that the second mode may be employed if necessary.

Where the determined value is below the predetermined threshold at Box 140, the process may proceed to Box 150 wherein engine 10 will be operated in the second mode and electronic controller 30 may command injection of a fuel charge via the second spray pattern of injector 50 in at least one subsequent engine cycle, or via both the first spray pattern and the second spray pattern in the at least one subsequent engine cycle. The control process illustrated in flowchart 100 may be an open-loop control process, as described herein. Accordingly, the timing, duration, injection pressure, etc. of fuel injection in the second mode may be mapped to the value indicative of boost pressure determined in Box 130.

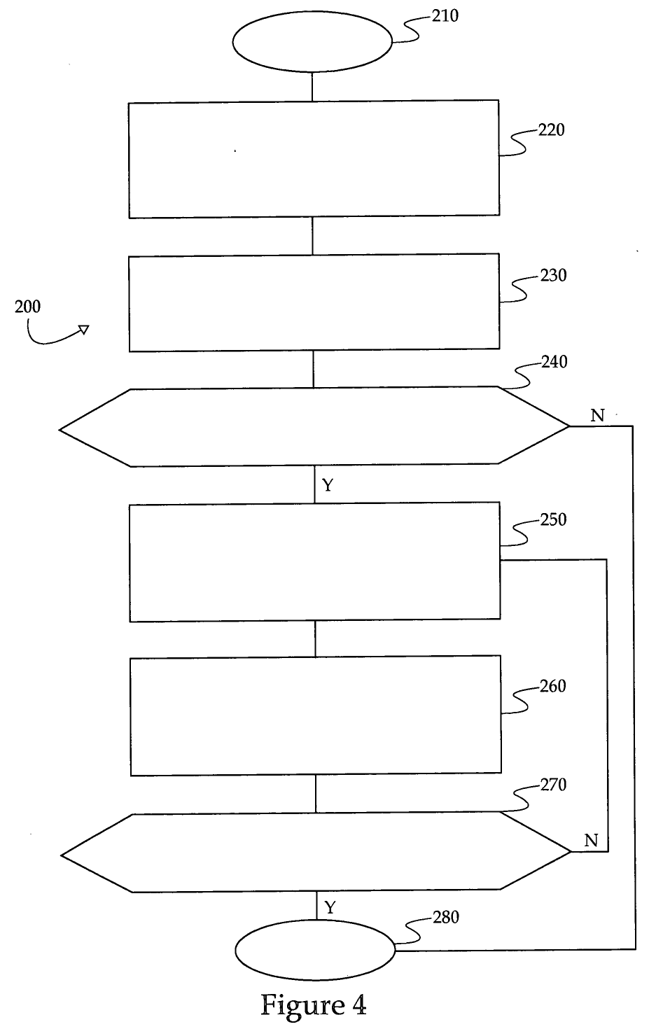

Turning to FIG. 4, there is shown a flowchart 200 illustrating another exemplary control process according to the present disclosure. The process illustrated in FIG. 4 may include a closed loop control process, as described herein. The process begins at Box 210, a START, and thenceforth proceeds to Box 220 wherein electronic controller 30 may operate engine 10 in the first mode and command injection of a fuel charge via the first spray pattern of injector 50 in a given engine cycle. From Box 220 the process may proceed to Box 230 wherein determination of the value indicative of boost pressure may take place, as described herein. From Box 230, the process may proceed to Box 240, wherein electronic controller 30 may query whether the value is below a predetermined threshold. If no, the process may proceed directly to a FINISH, Box 280.

If the value indicative of boost pressure is below the predetermined threshold at Box 240, the process may proceed to Box 250 wherein electronic controller 30 may operate engine 10 in the second mode and command injection of a supplemental fuel charge via the second spray pattern of injector 50 in at least one subsequent engine cycle, as described herein. From Box 250, the process may proceed to Box 260 wherein electronic controller 30 may determine a value indicative of at least one of cylinder pressure and a rate of change in cylinder pressure in cylinder 20. From Box 260 the process may proceed to Box 270 wherein electronic controller 30 may query whether the determined value is below a predetermined threshold. If no, the process may return from Box 270 to Box 250. If yes, the process may proceed to Box 280, a FINISH.

The process shown in flowchart 200 allows electronic controller 30 to monitor cylinder pressure and cylinder pressure rise rates, using supplemental, conventional fuel injections in the second operating mode, for example, to ensure that hardware limitations are not exceeded. In this fashion, the control logic will operate closed loop, with electronic controller 30 commanding conventional injections until cylinder pressure and pressure spikes are brought within desired limits, and may continue to operate so long as engine 10 is in a power range where the described supplemental conventional injection may be necessary to provide appropriate boost pressure.

The process of flowchart 200 further offers the advantage of allowing HCCI to account for as much of the power demand on engine 10 as is practicable, without needing to resort to excessive conventional operation to ensure damage to the system is avoided. In other words, by running closed loop, conventional fuel injection quantities or frequency may be used to keep cylinder pressures under control, with as much of the power demand as practicable provided by HCCI operation. Once cylinder pressures are brought within manageable limits, the conventional injections may be discontinued.

The present description is for illustrative purposes only, and should not be construed to narrow the breadth of the present disclosure in any fashion. Thus, those skilled in the art will appreciate that various alterations might be made to the presently disclosed embodiments without departing from the intended spirit and scope of the present disclosure. For example, while the processes of flowcharts 100 and 200 contemplate determining a value indicative of boost pressure, cylinder pressure alone might be used to determine when more boost pressure is needed. Thus, cylinder pressures may be thought of as a “value indicative of” boost pressure. Such a strategy might be implemented in either of a closed loop or open loop design.

Further, while a mixed mode injector provides a practical implement strategy, a conventional injector might be used in accordance with the present disclosure. In such an embodiment, the first operating mode could consist of fuel injections prior to autoignition conditions, whereas the second operating mode might consist of mixed pre- and post-autoignition injections, or injections only after autoignition conditions in a given engine cycle.

Further still, while the predetermined criterion for the value indicative of boost pressure is described in the context of being a value below a predetermined threshold, alternatives are contemplated, for example a value within a predetermined range. For instance, at particularly low power levels, the fuel quantity injected may not be large enough to raise concerns about damaging the engine hardware, even if operating in pure HCCI. Once the power demand and fuel injection quantities are increased, however, a risk of engine hardware damage may develop prior to a point at which turbocharger boost pressure is sufficient to influence the cylinder pressures. The second operating mode may thus be selectively used where the value indicative of boost pressure lies within a predetermined range. Other aspects, features and advantages will be apparent upon a further examination of the attached drawing Figures and appended claims.

What is claimed is:

1. A method of operating an internal combustion engine that includes at least one cylinder having a fuel injector disposed at least partially therein, comprising the steps of:
operating the engine in a first mode that includes injecting a fuel charge into the at least one cylinder prior to a time at which autoignition conditions have arisen in a given engine cycle;
determining a value indicative of a boost pressure of a turbocharger coupled with the engine; and
selectively operating the engine in a second mode that includes injecting a fuel charge into the at least one cylinder after a time at which autoignition conditions have arisen in at least one subsequent engine cycle, if the determined value meets a predetermined criterion.

2. The method of claim 1 wherein the step of selectively operating the engine in a second mode further includes injecting another fuel charge into the at least one cylinder prior to the time at which autoignition conditions have arisen in the at least one subsequent engine cycle.

3. The method of claim 2 wherein the step of selectively operating the engine in a second mode includes:
injecting a first fuel charge into the at least one cylinder via a first spray pattern of the fuel injector; and
injecting a second fuel charge into the at least one cylinder via a second spray pattern of the fuel injector different from the first spray pattern.

4. The method of claim 3 wherein the step of selectively operating the engine in a second mode includes:
injecting the first fuel charge at least in part by moving a first check to open or close a first set of outlet orifices of the fuel injector defining the first spray pattern; and
injecting the second fuel charge at least in part by moving a second check to open or close a second set of outlet orifices of the fuel injector separate from the first set, and defining the second spray pattern.

5. The method of claim 2 wherein the step of selectively operating the engine in a second mode includes, operating the engine in said mode if the determined value indicative of boost pressure is below a predetermined threshold.

6. The method of claim 5 wherein the step of selectively operating the engine in a second mode includes injecting a first fuel charge at a first time in the at least one subsequent engine cycle, and a second fuel charge smaller than said first fuel charge at a second, later time in the at least one subsequent engine cycle.

7. The method of claim 5 wherein the step of selectively operating the engine in the second mode includes selectively operating the engine in said second mode, where the engine is in a lower portion of an available power range.

8. The method of claim 7 further comprising the step of determining a value indicative of at least one of a cylinder pressure and a rate of change in cylinder pressure of the at least one cylinder.

9. The method of claim 7 wherein the step of determining a value indicative of boost pressure comprises determining the value at least in part with a temperature sensor disposed at least partially within an exhaust system of the internal combustion engine.

10. The method of claim 7 wherein the step of determining a value indicative of boost pressure comprises determining the value at least in part with a pressure sensor exposed to a fluid pressure of an intake manifold of the internal combustion engine.

11. The method of claim 7 wherein the step of determining a value indicative of boost pressure comprises determining the value at least in part with a speed sensor coupled with a turbocharger shaft of the turbocharger.

12. An internal combustion engine comprising:
an engine housing including at least one cylinder;
a fuel injector disposed at least partially within said at least one cylinder;
a turbocharger;
means for determining a value indicative of a boost pressure of said turbocharger; and
an electronic controller coupled with said turbocharger and with said means for determining, said electronic controller including a computer readable medium having a control algorithm recorded thereon, said control algorithm including means for operating the engine in a first mode that includes injecting a fuel into said at least one cylinder prior to a time at which autoignition conditions have arisen in the at least one cylinder, and means for selectively operating the engine in a second mode that includes injecting a fuel into said at least one cylinder after a time at which autoignition conditions have arisen in the at least one cylinder, if the determined value meets a predetermined criterion.

13. The internal combustion engine of claim 12 wherein said means for selectively operating the engine in a second mode comprises:
first means for injecting a fuel into said at least one cylinder prior to a time at which autoignition conditions have arisen during a given engine cycle; and
second means for injecting a fuel into said at least one cylinder after the time at which autoignition conditions have arisen during the given engine cycle.

14. The internal combustion engine of claim 13 wherein:
said fuel injector is a mixed mode fuel injector including a first set of injection orifices disposed at a first average spray angle relative to an axis of the at least one cylinder, and defining a first spray pattern, and a second set of injection orifices disposed at a second average spray angle relative to said axis that is larger than said first average spray angle, and defining the second spray pattern;
said first means includes means for injecting fuel via said first spray pattern; and
said second means includes means for injecting fuel via said second spray pattern.

15. The internal combustion engine of claim 13 wherein said means for selectively operating the engine in the second mode includes means for selectively operating the engine in the second mode, if the determined value is below a predetermined threshold.

16. The internal combustion engine of claim 15 further comprising:
a piston reciprocable at least partially within said at least one cylinder; and
means for determining a value indicative of a crank angle of the internal combustion engine during the at least one subsequent engine cycle;
said means for selectively operating the engine in the second mode including means for injecting a first fuel charge at a time during the at least one subsequent engine cycle prior to a predetermined crank angle range, and means for injecting a second fuel charge at another time during the at least one subsequent engine cycle after the predetermined crank angle range.

17. The internal combustion engine of claim 16 further comprising:
means for determining a power output of said engine; and
means for disabling said control algorithm where the power output is above a predetermined threshold.

18. The internal combustion engine of claim 16 wherein said control algorithm includes an open loop control algorithm including at least one map.

19. The internal combustion engine of claim 16 further comprising:
means for determining a value indicative of at least one of a cylinder pressure and a rate of change in cylinder pressure of the at least one cylinder;
wherein said control algorithm includes a closed loop control algorithm including a feedback term corresponding to the determined value indicative of said at least one of cylinder pressure and rate of change in cylinder pressure.

20. An article comprising:
a computer readable medium having a control algorithm recorded thereon, said control algorithm including means for determining a value indicative of a boost pressure of a turbocharger in an internal combustion engine having at least one cylinder with a fuel injector disposed at least partially therein, said control algorithm further including first means for operating said engine in a homogeneous charge mode where the determined value is above a predetermined threshold, and second means for selectively operating said engine in a mixed homogeneous charge and conventional mode where the determined value is below the predetermined threshold.
